(19) United States
(12) Patent Application Publication
(10) Pub. No.: US 2023/0331592 A1
(43) Pub. Date: Oct. 19, 2023

(54) LOW SALINITY INJECTION WATER COMPOSITION AND GENERATION FOR ENHANCED OIL RECOVERY

(71) Applicant: BP EXPLORATION OPERATING COMPANY LIMITED, Middlesex (GB)

(72) Inventors: John William COUVES, Bourne End, Buckinghamshire (GB); Stuart William DAY, Hampton, Middlesex (GB); Chris GIBSON, Guildford, Surrey (GB); Bilal RASHID, London (GB); John Dale WILLIAMS, Beaconsfield, Buckinghamshire (GB)

(73) Assignee: BP EXPLORATION OPERATING COMPANY LIMITED, Middlesex (GB)

(21) Appl. No.: 17/768,444

(22) PCT Filed: Oct. 16, 2020
(86) PCT No.: PCT/GB2020/052622

§ 371 Date: Apr. 12, 2022

(30) Foreign Application Priority Data
Oct. 16, 2019 (GB) 1914975.6

(51) Int. Cl. C02F 1/44; C09K 8/58

(52) U.S. Cl. CPC C02F 1/441; C09K 8/58; C02F 2103/08

(57) ABSTRACT

An integrated system comprising a desalination plant comprising a reverse osmosis (RO) array configured to produce an RO permeate blending stream, a blending system comprising a flow line for a fines stabilizing additive blending stream and configured to blend the RO permeate blending stream with the fines stabilizing additive blending stream to produce a blended low salinity water stream having a salinity of less than or equal to 5,000, 4,000, 3,000, 2,000, 1,000, 500, 400, or 300 ppm and a molar ratio of divalent cations to monovalent cations of greater than about 0.2, 0.3, or 0.4, a control unit configured to control operation of the blending system, and an injection system for one or more injection wells, wherein the one or more injection wells penetrate an oil-bearing layer of a reservoir. A method is also provided.

### CROSS-REFERENCE TO RELATED APPLICATIONS

This application is a 35 U.S.C. § 371 U.S. National Stage Entry application of PCT/GB2020/052622 filed Oct. 16, 2020, and entitled “Low Salinity Injection Water Composition and Generation for Enhanced Oil Recovery,” which claims priority to GB Application No. 1914975.6 filed Oct. 16, 2019, and entitled “Low Salinity Injection Water Composition and Generation for Enhanced Oil Recovery,” each of which is hereby incorporated herein by reference in its entirety for all purposes.

### STATEMENT REGARDING FEDERALLY SPONSORED RESEARCH OR DEVELOPMENT

Not applicable.

### TECHNICAL FIELD

The present disclosure relates to a system and method for producing a low salinity injection water for use during a low salinity water flood, and a composition thereof; more particularly, the present disclosure relates to a low salinity injection water composition comprising a reverse osmosis (RO) permeate and a fines stabilizing additive, and a system and method for producing same; still more particularly, this disclosure relates to a low salinity injection water having a higher than conventional molar ratio of divalent cations to monovalent cations, such that a salinity of the low salinity injection water can be lower than conventionally utilized for enhanced oil recovery (EOR) and/or utilizes potassium ions (such as, for example, KCl) to stabilize fines while maintaining injectivity and permeability of a reservoir.

### BACKGROUND

A problem associated with low salinity water-flooding is that desalination techniques may yield water having a lower than useful salinity for continuous injection into an oil bearing reservoir if, for example, the desalinated water injection causes swelling of clays, permeability loss, or migration of fines in the formation. In such instances, the desalinated water may be damaging to the oil-bearing rock formation of the reservoir and may inhibit oil recovery. Typically, where an oil-bearing formation comprises rock that contains high levels of swelling clays and/or is susceptible to fines damage, formation damage may be avoided, while still releasing oil from the formation, when the injection water has a sufficient total dissolved solids content (TDS).

A further problem associated with low salinity water-flooding is that the sulfate level of the low salinity injection water should typically be controlled to a value of less than 100 mg/L (e.g., less than 50 mg/L or less than 40 mg/L) in order to mitigate the risk of souring or scaling of the reservoir. Souring arises through the proliferation of sulfate-reducing bacteria that use sulfate in their metabolic pathway, thereby generating hydrogen sulfide. Scaling arises from deposition of mineral scale upon mixing of a sulfate containing injection water with connate water containing precipitate precursor cations such as barium cations.

### SUMMARY

Herein disclosed is an integrated system comprising: a desalination plant comprising a reverse osmosis (RO) array configured to produce an RO permeate blending stream; a blending system comprising a flow line for a fines stabilizing additive blending stream and configured to blend the RO permeate blending stream with the fines stabilizing additive blending stream to produce a blended low salinity water stream having a salinity of less than or equal to 8,000, 7,000, 6,000, 5,000, 4,000, 3,000, 2,000, 1,000, 500, 400, or 300 ppm and a molar ratio of divalent cations to monovalent cations of greater than about 0.2, 0.3, or 0.4; a control unit configured to control operation of the blending system; and an injection system for one or more injection wells, wherein the one or more injection wells penetrate an oil-bearing layer of a reservoir.

Also disclosed herein is a method comprising: producing a reverse osmosis (RO) permeate blending stream using an RO array of a desalination plant; providing a fines stabilizing additive blending stream; blending the RO permeate blending stream and the fines stabilizing additive blending stream in a blending system to produce a blended low salinity water stream having a salinity of less than or equal to 5,000, 4,000, 3,000, 2,000, 1,000, 500, 400, or 300 ppm and a molar ratio of divalent cations to monovalent cations of greater than or equal to about 0.2, 0.3, or 0.4.

Further disclosed herein is an integrated system comprising: a control unit; a plurality of valves controlled by the control unit; a plurality of flow rate and composition monitors configured to provide measured flow rate data and composition data, respectively, to the control unit; a reverse osmosis (RO) array configured to produce an RO permeate blending stream; a fines stabilizing additive tank configured to provide a fines stabilizing additive blending stream; and a blending system comprising a line configured to blend the RO permeate blending stream and the fines stabilizing additive blending stream into a blended low salinity water stream having a salinity of less than or equal to 5,000, 4,000, 3,000, 2,000, 1,000, 500, 400, or 300 ppm and a molar ratio of divalent cations to monovalent cations of greater than or equal to about 0.2, 0.3, or 0.4, wherein the control unit is configured to: adjust, in response to the measured flow rate and composition data, at least one of the plurality of valves to maintain a composition of the blended low salinity water stream within a predetermined operating envelope.

Also disclosed herein is a low salinity injection fluid for use in enhanced oil recovery (EOR), the low salinity injection fluid comprising: a reverse osmosis (RO) permeate stream (e.g., an RO permeate stream or an RO/NF stream) that corresponds to from about 80 to about 99.995 volume percent (vol %) of the low salinity injection fluid, and a fines stabilizing additive that corresponds to from about 0.005 to about 20 vol % of the low salinity injection fluid. In embodiments, the fines stabilizing additive comprises a salt of a divalent cation.

### BRIEF DESCRIPTION OF THE DRAWINGS

For a detailed description of embodiments of this disclosure, reference will now be made to the accompanying drawings in which:

FIG. 1 is a schematic view of an embodiment of an integrated system I for producing a blended low salinity injection water for use during low salinity water-flooding, according to an embodiment of this disclosure;

FIG. 2 is a schematic view of an embodiment of an integrated system II for producing a blended low salinity injection water for use during low salinity water-flooding, according to another embodiment of this disclosure; and

FIG. 3 is a schematic view of an embodiment of an integrated system III for producing a blended low salinity injection water for use during low salinity water-flooding, according to another embodiment of this disclosure.

### DETAILED DESCRIPTION

It should be understood at the outset that although an illustrative implementation of one or more embodiments are provided below, the disclosed compositions, methods, and/or products may be implemented using any number of techniques, whether currently known or not yet in existence. The disclosure should in no way be limited to the illustrative implementations, drawings, and techniques illustrated hereinbelow, including the exemplary designs and implementations illustrated and described herein, but may be modified within the scope of the appended claims along with their full scope of equivalents.

### Definitions

While the following terms are believed to be well understood by one of ordinary skill in the art, the following definitions are set forth to facilitate explanation of the presently disclosed subject matter. Unless defined otherwise, all technical and scientific terms used herein have the same meaning as commonly understood to one of ordinary skill in the art to which the presently disclosed subject matter belongs.

Throughout the following description the following terms are referred to:

“High salinity feed water” is the feed water to a desalination plant and is typically seawater (SW), estuarine water, aquifer water or mixtures thereof.

The unit “ppmv” is “parts per million on a volume of water basis” and is equivalent to the unit “mg/L”.

A “reverse osmosis (RO) filtration unit” comprises a pressure vessel, alternatively called a housing, containing one or more RO membrane elements; for example, between 1 and 8 RO membrane elements and, in particular, between 4 and 8 RO membrane elements.

A “nanofiltration (NF) filtration unit” comprises a pressure vessel containing one or more NF elements; for example, between 1 and 8 membrane elements, or between 4 and 8 NF membrane elements.

A “reverse osmosis (RO) stage of a desalination plant” is a group of RO filtration units connected together in parallel. Similarly, a “nanofiltration (NF) stage of a desalination plant” is a group of NF filtration units connected together in parallel.

A “membrane block” comprises stages of RO and/or NF filtration connected together to provide concentrate staging and typically shares common valving and piping. A single membrane block or a plurality of membrane blocks may be mounted on a skid.

“Produced water (PW)” is water separated from oil and gas at a production facility. Produced water may comprise connate water, invading aquifer water from an underlying aquifer or any previously injected aqueous fluid such as seawater (SW).

“Connate water” is the water present in the pore space of an oil-bearing layer of a reservoir.

“Aqueous drive fluid” is an aqueous fluid that may be injected into an injection well after injection of a low pore volume (PV) slug of the blended low salinity injection water.

“Bank of oil” is a term well known to the person skilled in the art and refers to a portion of the layer(s) of reservoir rock where the oil saturation is increased because of the application of an enhanced oil recovery process that targets immobile oil.

“Main phase of a low salinity waterflood” refers to a phase of the low salinity waterflood following commissioning of a low salinity injection well.

“Commissioning of a low salinity injection well” refers to a period of up to several days during which the salinity of the injection water may be gradually reduced or there may be stepped reductions in salinity until the composition of the injection well falls within an operating envelope for the main phase of the low salinity waterflood.

An “injection system” comprises an injection line and one or more injection pumps for pumping injection water through an injection well and injecting the injection water into the formation.

An “injection site” is the site of the injection system and may be onshore or offshore (e.g., on a platform or Floating Storage and Offloading (FPSO) vessel).

“Injectivity” means the relative ease in which a fluid (e.g., an injection water) is injected into an oil-bearing layer of a reservoir.

“Permeability loss” means a loss in the capacity of a rock layer to transmit water or other fluids, such as injection fluids or oil, having a value of at least 10% of the permeability measured prior to a treatment process such as a low salinity water flood.

A “blending system” comprises a plurality of feed lines for feeding blending streams leading to at least one blending point(s) and a discharge line for discharging a blended injection water stream from the blending point(s).

“TDS concentration” or “TDS content” is the total concentration of dissolved solids and typically has units of ppmv (mg/L). In the case of an aqueous stream in some embodiments described herein, the dissolved solids are ions such that the TDS concentration is a measure of the salinity of the aqueous stream.

As utilized herein, the ‘ionic strength’ is a measure of the concentration of ions in the solution.

Sodium Adsorption Ratio (SAR) is used to assess the state of flocculation or of dispersion of clays in the reservoir rock. Typically, sodium cations facilitate dispersion of clay particles while calcium and magnesium cations promote their flocculation. A formula for calculating the Sodium Adsorption Ratio (SAR) is:

SAR=[Na⁺]/{√(0.5*([Ca²⁺]+[Mg²⁺]))},

wherein sodium, calcium, and magnesium cation concentrations of the blended injection water are expressed in milliequivalents/liter.

“Quality” of a stream relates to the total dissolved solids content and/or the concentrations of individual ions or types of individual ions and/or ratios of individual ions or ratios of types of individual ions in the stream.

“Swept pore volume” is the pore volume of the layer(s) of reservoir rock swept by the injected fluids (low salinity injection water and any aqueous drive fluid) between an injection well and production well, averaged over all flow paths between the injection well and production well. Where an injection well has two or more associated production wells, the term “swept pore volume” means the pore volume of the layer(s) of reservoir rock swept by the injected fluids between the injection well and its associated production wells.

“Slug” is a low pore volume of a fluid that is injected into an oil-bearing layer of a reservoir. The values of pore volumes given for the slugs of low salinity injection water are based on the swept pore volume of the layer(s) of reservoir rock.

“Fines” are small particles (e.g., having a size characterized by a diameter of less than or equal to about 4, 3, 2 or 1 μm) produced as a result of formation damage during EOR. Such fines include, without limitation, clay fines, silica, and other minerals.

### Overview

As noted hereinabove, a downside of injecting low ionic strength water into a formation (e.g., a sandstone formation) is that clay swelling and fines migration can result in pore blocking and/or permeability loss. In order to deploy low salinity water injection commercially in the field there is a balance between utilizing a low salinity injection water having a low enough salinity to produce additional oil and a high enough salinity to prevent formation damage. As formation damage can be a significant issue commercially, operation typically occurs with a higher salinity injection water, the use of which may erode some of the potential enhanced oil recovery benefit. As RO and NF tend to preferentially reject divalent cations relative to monovalent cations and divalent cations tend to reduce the production of fines and swelling of clays, the salinity of a blended RO/NF permeate is conventionally increased (e.g., via an increase in a volume ratio of NF relative to RO permeate and/or the addition of sea water (SW) or produced water (PW)) to provide a blended low salinity injection water of sufficient salinity to reduce the likelihood of formation damage. However, blending of the multiple streams (e.g., RO permeate, NF permeate, SW and/or PW) can be complicated and equipment intensive. Further, the concentration of the multivalent ions in the low salinity injection water is limited by the relatively low concentration of multivalent ions in SW or PW, which is then further reduced based on the blending.

The present disclosure relates to a simplified, integrated system and a method for producing a blended low salinity water for injection into an oil reservoir which aims to reduce the risk of formation damage. The herein-disclosed low salinity injection water comprises a clay swelling/fines stability chemical (referred to herein as a ‘fines stabilizing additive’) in combination with an RO permeate (and potentially no NF permeate). Utilization of a low salinity injection water as disclosed herein during low salinity water flooding can enable a substantial reduction in a salinity of the injection water without a loss of permeability. The integrated system and method disclosed herein can be utilized to produce a blended low salinity injection water of varying composition (e.g., having a continuously or step-wise decreasing salinity) for injection into an injection well during commissioning of a well and/or within a predetermined operating envelope for the main phase of a low salinity waterflood. Utilization of the herein disclosed low salinity injection water can enhance oil recovery from a reservoir while reducing the risk of formation damage, souring, and/or scaling of the reservoir.

The herein disclosed system and method for producing the low salinity injection water of this disclosure allows the facilities to produce low salinity water by a simplified process which requires less equipment to be used with the overall water injection system. For example, according to this disclosure, nanofiltration (NF) may not be used for the production of the low salinity injection water in some embodiments. In some embodiments, elimination of NF water as a blending stream, along with the costs, equipment, and complication associated therewith, can reduce cost, facilitate low salinity injection water manufacturing, facilitate installation of a low salinity injection water system, simplify water quality requirements for initial well injection start-up, and/or increase overall low salinity water injection operability. In other embodiments, NF is utilized, for example, with calcium addition.

According to this disclosure, facilities for producing low salinity water for injection provide for the addition of a chemical stabilizer (also referred to herein as a ‘fines stabilizing additive’) to a permeate from a reverse osmosis (RO) unit so that the resulting low salinity injection water has a low salinity (e.g., lower than conventional EOR injection water, which has a salinity in a range of from about 500 or 1,000 to 5,000, 8,000, or 10,000 ppm). In some embodiments, the fines stabilizing additive can comprise a salt of a divalent cation, such as calcium or magnesium and/or may include potassium, and can enable control of permeability loss at a lower overall salinity of the low salinity injection water. For example, in some embodiments, the herein disclosed low salinity injection water has a salinity of less than or equal to about 300, 400, or 500 ppm, and can be injected directly into an oil reservoir during a low salinity water flood. In some embodiments, as noted above, the herein disclosed system and method allow for the use of a nanofiltration (NF) array and the production of an NF permeate blending stream to blend with the RO permeate to form the low salinity injection water to be reduced or potentially eliminated, thus simplifying the facilities (e.g., water treatment or ‘desalination’ facilities and water injection facilities) and the method of producing the low salinity injection water. In some embodiments, the low salinity injection water produced via the herein disclosed system and method is a low salinity water with high hardness (e.g., a hardness, as measured by calcium carbonate equivalent). In some embodiments, utilization of a low salinity injection water of this disclosure provides for a reduced likelihood of permeability loss during low salinity water flooding, while not reducing (or in some embodiments even enhancing) the resulting low salinity EOR response.

In some embodiments, the integrated system comprises a desalination plant including a reverse osmosis (RO) array to produce an RO permeate blending stream. The integrated system also comprises one or more flow lines for a fines stabilizing additive blending stream and a blending system configured to blend the RO permeate blending stream with the fines stabilizing additive blending stream to produce a blended low salinity water stream. In some embodiments, the blending system provides a blended low salinity water stream having salinity of less than or equal to 5,000, 4,000, 3,000, 2,000, 1,000, 500, 400, or 300 ppm, or less (e.g., a salinity that may be close to the salinity of a permeate of an RO membrane) and a molar ratio of divalent cations to monovalent cations of greater than or equal to about 0.2, 0.3, or 0.4. The integrated system further comprises a control unit configured to control operation of the blending system and an injection system for one or more injection wells that penetrate an oil-bearing layer of a reservoir. The control unit can be configured to dynamically alter operation of the blending system to adjust amounts of at least one of the RO permeate blending stream or the fines stabilizing additive blending stream to maintain a composition of the blended low salinity water stream within a predetermined operating envelope. In some embodiments, some amount of SW or PW can also be blended into the low salinity injection water stream. In some embodiments, the predetermined operating envelope includes the salinity of less than or equal to 5,000, 4,000, 3,000, 2,000, 1,000, 500, 400, or 300 ppm, or less and a molar ratio of divalent cations to monovalent cations of greater than or equal to about 0.2, 0.3, or 0.4. The control unit can be configured to receive the operating envelope from a source external to the control unit. In some embodiments, the operating envelope specifies upper and lower limits for at least one parameter selected from the group consisting of: total dissolved solids (TDS) content; ionic strength; concentrations of individual ions; concentration of types of individual ions; ratios of types of individual ions; and ratios of individual ions. In some embodiments, the at least one parameter comprises a molar ratio of divalent cations to monovalent cations. The integrated system can further comprise an RO permeate dump line, a high salinity desalination feed water (e.g., sea water (SW)) bypass line, a produced water (PW) blending line, or a combination thereof, and the control unit can be further configured to dynamically adjust an amount of the RO permeate discharged from the blending system via the RO permeate dump line, an amount of a high salinity water by-pass stream that by-passes the desalination plant via the bypass line and feeds high salinity feed water to the blending system, an amount of a PW stream that feeds PW to the blending system via the PW blending line, or a combination thereof to produce the blended low salinity water stream. In some embodiments, the integrated system can further include a production facility to separate fluids produced from one or more production wells that penetrate the oil-bearing layer of the reservoir and to deliver a produced water (PW) stream to the blending system. In some embodiments, (i) the RO permeate stream corresponds to from about 75, 80, or 85 to about 99, 99.9, 99.99, or 99.995 volume percent (vol %) of the blended low salinity water stream, and the fines stabilizing additive blending stream can correspond to from about 0.005, 0.008, or 0.01 to about 15, 20, or 25 vol % of the blended low salinity water stream. In some embodiments, the (ii) the fines stabilizing additive blending stream comprises calcium chloride (CaCl₂)), calcium nitrate (Ca(NO₃)₂), potassium chloride (KCl), potassium nitrate (KNO₃), ammonium chloride ((NH₄)Cl), magnesium chloride (MgCl₂), or a combination thereof. In some embodiments, the integrated system is configured for both (i) and (ii).

In some embodiments, a method comprises producing a reverse osmosis (RO) permeate blending stream using an RO array of a desalination plant, providing a fines stabilizing additive blending stream, and blending the RO permeate blending stream and the fines stabilizing additive blending stream in a blending system to produce a blended low salinity water stream. In some embodiments, the blended low salinity water stream has a salinity of less than or equal to 5,000, 4,000, 3,000, 2,000, 1,000, 500, 400, or 300 ppm, or less (e.g., a salinity that may be close to the salinity of a permeate of an RO membrane) and/or a molar ratio of divalent cations to monovalent cations of greater than or equal to about 0.2, 0.3, or 0.4. In some embodiments, the method further comprises dynamically adjusting operation of the blending system to adjust amounts of the RO permeate blending stream, the fines stabilizing additive blending stream, or both to maintain a composition of the blended low salinity water stream within a predetermined operating envelope. The predetermined operating envelope can include the salinity of less than or equal to 5,000, 4,000, 3,000, 2,000, 1,000, 500, 400, or 300 ppm, or less and/or a molar ratio of divalent cations to monovalent cations of greater than or equal to about 0.2, 0.3, or 0.4. In some embodiments, the blended low salinity water stream has a divalent cation content in a range of from about 0.01 to about 20, from about 0.05 to about 15, or from about 0.01 to about 10 milliequivalents/liter (meq/L). In some embodiments, blending further comprises blending seawater (SW), produced water (PW), or both with the RO permeate blending stream and the fines stabilizing additive blending stream in the blending system to produce the blended low salinity water stream. Dynamically adjusting the operation of the blending system can comprise adjusting at least one valve in the blending system. The at least one valve can comprise a valve on a fines stabilizing additive blending line that feeds the fines stabilizing additive blending stream to the blending system, a valve on an RO permeate dump line, a valve on a high salinity water by-pass line that by-passes the desalination plant and feeds sea water (SW) to the blending system, a valve on a produced water (PW) blending line that feeds PW to the blending system, or a combination thereof.

In some embodiments, an integrated system comprises a control unit, a plurality of valves controlled by the control unit, a plurality of flow rate and composition monitors configured to provide measured flow rate data and composition data, respectively, to the control unit, a reverse osmosis (RO) array configured to produce an RO permeate blending stream, a fines stabilizing additive tank configured to provide a fines stabilizing additive blending stream, and a blending system comprising a line configured to blend the RO permeate blending stream and the fines stabilizing additive blending stream into a blended low salinity water stream. The control unit can be configured to adjust, in response to the measured flow rate and composition data, at least one of the plurality of valves to maintain a composition of the blended low salinity water stream within a predetermined operating envelope. The blended low salinity water stream can have a salinity of less than or equal to 5,000, 4,000, 3,000, 2,000, 1,000, 500, 400, or 300 ppm, or less and/or a molar ratio of divalent cations to monovalent cations of greater than or equal to about 0.2, 0.3, or 0.4. In some embodiments, the flow rate data and composition data pertain to the blended low salinity water stream. The integrated system can further comprise an injection system configured to deliver the blended low salinity water stream to a formation via an injection well. In some embodiments, the operating envelope specifies upper and lower limits for at least one parameter selected from the group consisting of: total dissolved solids (TDS) content; ionic strength; concentrations of individual ions; concentration of types of individual ions; ratios of types of individual ions; and ratios of individual ions. In some embodiments, the plurality of valves includes a valve on an RO permeate dump line, and the control unit is further configured to adjust an amount of the RO permeate discharged from the blending system via the valve on the RO permeate dump line. The integrated system can further comprise a sea water (SW) bypass line that by-passes the RO array and feeds sea water (SW) to the blending system, a produced water (PW) blending line that feeds PW to the blending system, or both.

### Integrated System and Method for Generating Low Salinity Injection Water

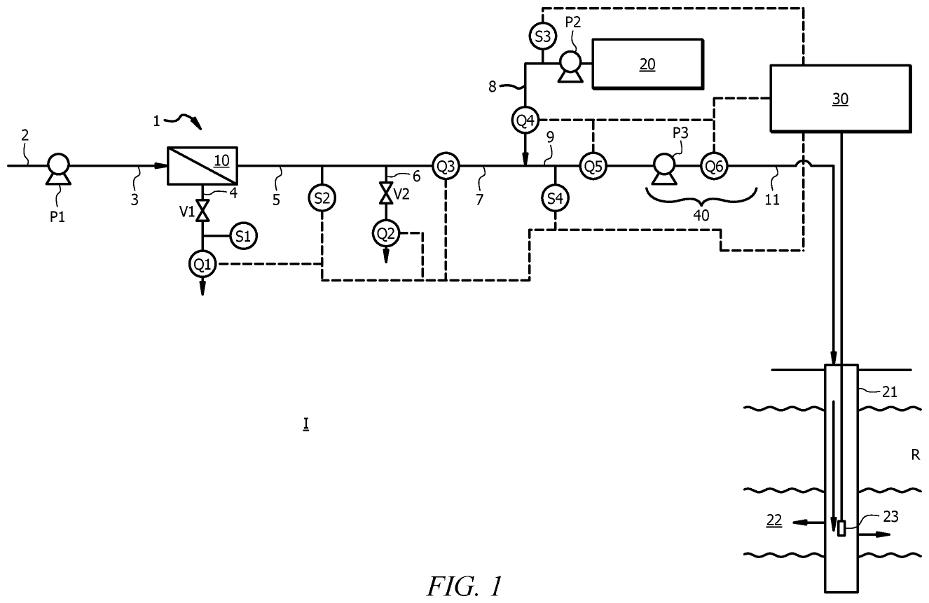

An integrated system of this disclosure will now be described with reference to FIG. 1, which is a schematic view of an embodiment of an integrated system I for producing a blended injection water for use during low salinity water-flooding, according to an embodiment of this disclosure. Integrated system I can comprise RO array 10, concentrate tank 20, control unit 30, and an injection system 40 comprising at least one injection line 11 and at least one injection pump P3 for injecting the low salinity injection water into an injection well 21 penetrating an oil bearing layer 22 of a reservoir R.

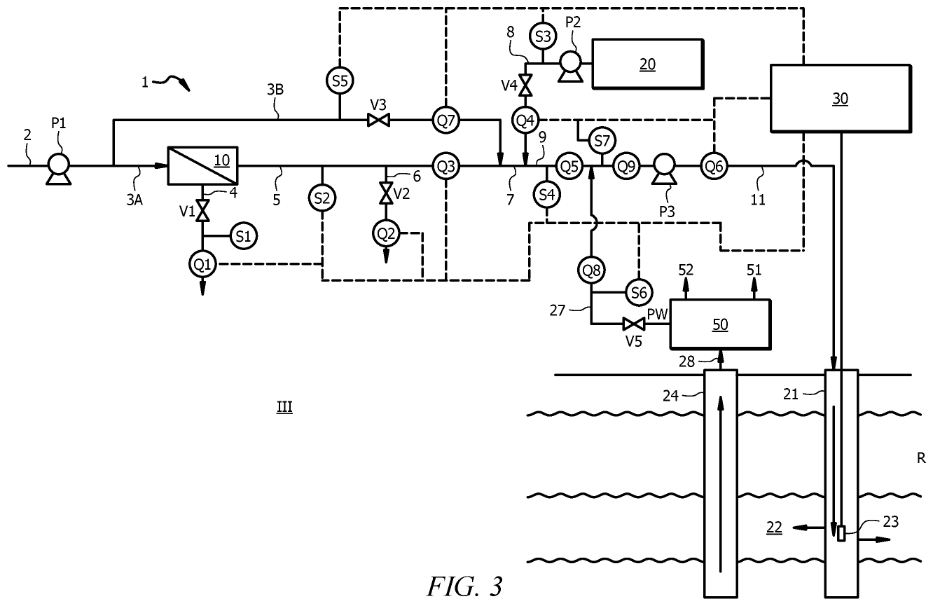

Integrated system I of FIG. 1 depicts a reservoir R having an oil-bearing layer 22 penetrated by a single injection well 21. In applications, an integrated system can comprise at least one injection well 21 and at least one production well 24 (as described further with reference to the embodiment of FIG. 3). Reservoir R can comprise a sandstone reservoir and/or a carbonate reservoir, in some embodiments. The integrated system I of the embodiment of FIG. 1 can comprise: a desalination plant comprised of a membrane block 1 for treating a feed water 2 (typically seawater (SW)); a fines stabilizer concentrate tank 20 and pump P2 for providing a fines stabilizing additive (e.g., concentrated) blending stream in fines stabilizing additive blending line 8; a blending system comprising various flow lines for forming a blended low salinity injection water as described herein; and, a control unit 30 for controlling the operation of the desalination plant and for controlling blending of the low salinity injection water stream in the blending system. The integrated system I also comprises an injection system 40 comprising one or more injection pumps P3 and injection lines 11 for the injection well 21. As described further with reference to the embodiment of FIG. 3, an integrated system of this disclosure can further comprise a production facility 50 in fluid communication with a production line 28 of a production well 24. Production facility 50 can also comprise a PW flow line 27, which may be in fluid communication with the blending system.

Membrane block 1 can comprise a feed pump P1, an RO array 10, which may be either a single or multistage array. The desalination feed water in feed water line 2 introduced via feed pump P1 and RO feed line 3 into RO array 10 may be a high salinity feed water. In some embodiments, the desalination feed water in feed water line 2 comprises sea water (SW), estuarine water, aquifer water, or a combination thereof. RO array 10 produces an RO permeate, extracted via RO permeate line 5, and an RO concentrate (also referred to in the art as an RO “retentate”), extracted via RO concentrate line 4. In some embodiments, an RO concentrate from a first RO stage may be utilized to form a feed stream for a second RO stage.

RO array 10 comprises a plurality of RO units. Typically, the number of units of the RO array is chosen to match the required production capacity of RO permeate for the blended low salinity injection water stream during the main phase of the low salinity waterflood.

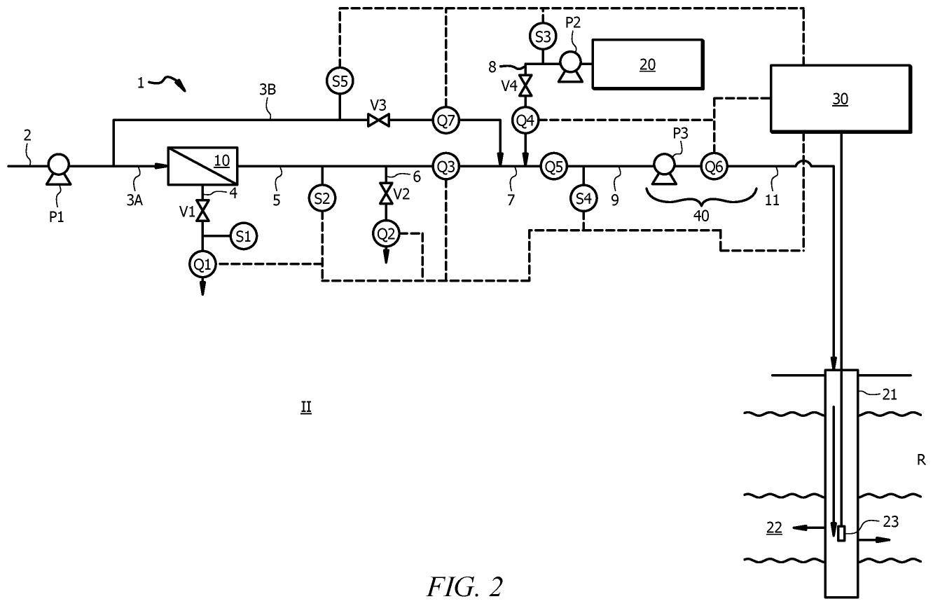

As illustrated in FIG. 2, which is a schematic of an embodiment of an integrated system II for producing a blended injection water for use as an injection water during low salinity water-flooding, the desalination plant may also be provided with a high salinity feed water by-pass line 3B for the feed water 2, such that a first portion of the feed water in feed water line 2 is introduced into RO array 10 via RO feed line 3A, and a second portion of the feed water in feed water line 2 by-passes RO array 10 via high salinity feed water by-pass line 3B. In such embodiments, the bended low salinity injection water can further comprise high salinity feed water (e.g., SW) in addition to the RO permeate and the fines stabilizing additive. For brevity, the high salinity desalination system feed water bypass line may also be referred to herein as a ‘SW bypass line’. The high salinity desalination system feed water can, however, comprise any suitable high salinity feed water, including, without limitation, seawater (SW), estuarine water, aquifer water, or a combination thereof.

As illustrated in FIG. 3, which is a schematic of an embodiment of an integrated system III for producing a blended injection water for use as an injection water during low salinity water-flooding, the fluids produced from a production well 24 are passed to a production facility 50 via a production line 28. The produced fluids are separated in the production facility 50 into an oil stream 51, a gaseous stream 52 and a produced water (PW) stream. In some embodiments, all or a portion of the PW flows via a PW blending stream and a PW blending line 27 to the blending system where it is combined with the RO permeate stream and the fines stabilizing additive blending stream (and optionally the high salinity by-pass water and additional additive(s)) flowing through line 9 to form the blended low salinity injection water stream. In such embodiments, the blended low salinity injection water can further comprise PW in addition to the RO permeate and the fines stabilizing additive. Although both SW by-pass and PW blending are indicated in the embodiment of FIG. 3, in some embodiments, PW blending is utilized without high salinity by-pass, in which case by-pass line 3B, ion concentration sensor S5, valve V3, and flow rate sensor Q7 (and associated communication with control unit 30) may be absent.

The blended low salinity injection water of this disclosure thus comprises RO permeate and fines stabilizing additive, and can optionally further comprise high salinity by-pass water, PW, other additive(s), or a combination thereof. In some embodiments, the RO permeate stream (or RO/NF blended stream) corresponds to from about 80 to about 99.995, from about 90 to about 99.995, or from about 97.25 to about 99.995 volume percent (vol %) of the blended low salinity injection water, and the fines stabilizing additive blending stream corresponds to from about 0.005 to about 20, from about 0.005 to about 10, from about 0.01 to about 0.05, or from about 0.005 to about 2.75 vol % of the blended low salinity injection water. In some embodiments, the fines stabilizing additive blending steam can correspond to at least 0.005, 0.008, 0.01, 0.02, 0.03, 0.04, or 0.05 vol % of the blended low salinity injection water, and the amount can depend on the solubility of the particular fines stabilizing additive. As described herein, the fines stabilizing additive blending stream can include the fines stabilizing additive in an amount sufficient to meet the salinity, salt concentration, divalent cation concentration, divalent to monovalent cation ratio, and/or total dissolved solids concentration desired in the final blended low salinity water stream.

The integrated systems I/II/III can comprise valves V1 to V5 and various flow lines (conduits) configured to provide the flow paths described below. Valves V1 to V5 may be throttle valves and the degree of opening of the throttle values may be set by the control unit 30 (e.g., fully open position, fully closed position, or various intermediate positions). Accordingly, the control unit 30 may control the flows and pressures through the membrane block by controlling the feed pump P1, valves V1 to V5 or any combination thereof (for clarity, electrical connections between the control unit 30, the feed pump P1, and the valves V1 to V5 are omitted from FIGS. 1-3; in some embodiments, communications between the control unit 30 and the feed pump P1 and valves V1 to V5 may comprise wireless communications, such as Wi-Fi or Bluetooth, wired communications, pneumatic signals, or the like).

Flow rate sensors Q1 to Q9 are provided for determining the flow rates in the various flow lines of the integrated system. Flow rate data may be sent from the flow rate sensors Q1-Q9 to the control unit 30 via signal pathways (the dotted lines in FIGS. 1-3) such as electrical signal lines, through wireless communications (e.g., Wi-Fi or Bluetooth communications), or the like.

One or more composition sensors such as ion concentration sensors (e.g., sensors S1 to S7), can also be provided for determining the total concentration of dissolved ions (TDS) and/or the concentration and/or molar ratio of individual ions or types of individual ions (such as multivalent cations or divalent cations or the molar ratio of divalent cations to monovalent cations) in the fluids in the various flow lines. Ion concentration data can also be sent from the ion concentration sensors S1-S7 to the control unit 30 via signal pathways (e.g., dotted lines shown in FIGS. 1-3). In some embodiments, one or more of the sensors S1-S7 may measure concentrations of individual ions such as one or more divalent cations including calcium (Ca), magnesium (Mg), strontium (Sr), barium (Ba) (the latter two, of present, at low levels), or a combination thereof, concentrations of monovalent cations including sodium (Na), potassium (K), other alkali metals, ammonium (NH₄) (the latter two, if present, at low levels), total ion concentration, and/or a combination thereof, from which the control unit 30 can calculate the molar ratio of divalent to monovalent cations as the sum of the concentrations of the divalent cations divided by the sums of the concentrations of the monovalent cations.

In the configuration of FIG. 1, feed pump P1 pumps feed water 2 to the RO array 10 via RO feed water line 3. Within RO array 10, the feed water is separated into an RO permeate (that flows through RO permeate feed line 5) to the blending system and an RO concentrate (that flows through RO concentrate line 4 and valve V1). The pressures of the feed water to the RO arrays may be adjusted (for example, using a booster pump for the RO feed) to match the operating pressures of the RO units of the RO array 10. Optionally, as depicted in the embodiment of FIG. 2, the feed pump P1 pumps a portion of the feed water (for example, SW) through the high salinity water by-pass line 3B to the blending system, and the RO permeate stream in line 5 is combined therewith to provide blended RO permeate/high salinity feed water in line 7. In some embodiments, valve V1 is at least partially open to provide a bleed of RO concentrate from the blending system via RO concentrate line 4. Ion concentration sensor S1 may be utilized to measure data regarding RO concentrate line 4, and flow rate sensor Q1 may be operable to determine the flow rate in RO concentrate line 4. Optionally, the flow rate sensor Q1 on the RO concentrate line 4 may be omitted. Optionally, the sensor S1 on the RO concentrate line 4 may be omitted. Typically, the RO concentrate bleed stream is discharged to a body of water (e.g. the sea) via RO concentrate line 4.

An ion sensor S2 may be operable to provide ion concentration data of the RO permeate in RO permeate line 5. In some embodiments, ion sensor S2, alone or in combination with other sensor data, may be operable to determine a molar ratio of divalent cations to monovalent cations in the RO permeate in RO permeate line 5. The flow rate of RO permeate in RO permeate line 5 may be determined by flow rate sensor Q3, and the flow rate of RO permeate may be rapidly adjusted via operation of RO permeate dump valve V2 to control the flow rate of RO permeate dumped via an RO permeate dump line 6 and provide a desired RO permeate flow rate in RO permeate line 7. A flow rate sensor Q2 may be positioned on RO permeate dump line 6 to measure the flow rate thereof.

Fines stabilizing additive blending stream in a fines stabilizing additive blending line 8 can be blended with the RO permeate stream in RO permeate line 7. The fines stabilizing additive can be blended with the RO permeate as a concentrated solution (e.g., a ‘concentrate’), or metered in as a powder. In some embodiments, the fines stabilizing additive concentrate has a concentration of greater than or equal to about 20 weight percent (wt %), 35 wt %, or 50 wt %. In some embodiments, the fines stabilizing additive blending stream comprises an aqueous solution of Ca(NO₃)₂ and/or CaCl₂) having a concentration of at least 20 wt %, 30 wt %, 40 wt %, 45 wt %, or 50 wt %. A concentrate tank 20 may be utilized to store the fines stabilizing additive, and the fines stabilizing additive may be pumped via fines stabilizing additive pump P2 at a desired flow rate into RO permeate line 7. A flow rate sensor Q4 may be utilized to measure the flow rate of the fines stabilizing additive in fines stabilizing additive blending line 8. An ion sensor S3 can be utilized to provide ion concentration data for fines stabilizing additive blending stream in fines stabilizing blending line 8. In some embodiments, ion sensor S3 may be operable to determine a molar ratio of divalent cations to monovalent cations in the fines stabilizing additive blending stream in fines stabilizing additive line 8. The sensor S3 on the fines stabilizing concentrate additive feed line 8 may be omitted if the concentration of the additive in the concentrate tank has previously been measured and remains stable over time (in which case, the measured concentration of fines stabilizing additive in the concentrate may be inputted into the control unit 30). It is also envisaged that the sensors S2 and S5 on the RO permeate line 5 and on the optional high salinity by-pass line 3B, respectively, may be omitted when the compositions of the RO permeate and the high salinity desalination feed water are predicted to remain substantially constant over time.

In some embodiments, the fines stabilizing additive may be an inorganic salt such as a salt of a divalent cation or a potassium and/or an ammonium salt. In some embodiments, the salt of the divalent cation may be a calcium or magnesium salt such as calcium chloride, calcium bromide, calcium nitrate, magnesium chloride, magnesium bromide or magnesium nitrate. In some embodiments, the salt of the divalent cation is calcium chloride or calcium nitrate. In some embodiments, the potassium salt is selected from potassium chloride, potassium bromide and potassium nitrate. Calcium nitrate or potassium nitrate may also have the advantage of providing souring control as the nitrate anion may encourage the growth of nitrate reducing bacteria that may out-compete sulfate reducing bacteria (SRB) for nutrients and assimilable organic carbon. In some embodiments, the fines stabilizing additive comprises calcium chloride (CaCl₂)), calcium nitrate (Ca(NO₃)₂), potassium chloride (KCl), potassium nitrate (KNO₃), ammonium chloride ((NH₄)Cl), magnesium chloride (MgCl₂), or a combination thereof. In some embodiments, the fines stabilizing additive comprises one or more salts of a divalent cation, such as calcium or magnesium. In some embodiments, the fines stabilizing additive comprises any calcium salt with a non-coordinating anion. The fines stabilizing additive utilized as a major component of the blended low salinity injection water according to this disclosure can be a clay stabilizing additive(s). As RO (and NF) tend to preferentially reject divalent cations relative to monovalent cations, the system and method of this disclosure allow for the selective addition of divalent cations back into the low salinity injection water by blending with the fines stabilizing additive as described herein. The selective addition of the divalent ions allows for the ratio of divalent ions to monovalent ions to be higher than that which can be achieved by using RO (and/or NF) with a high salinity desalination feed water by itself.

In some embodiments, the low salinity injection water comprises further additives, such as, without limitation, a clay stabilizing additive. In such embodiments, another additive tank (such as concentrate tank 20) can be utilized to introduce such additional additive(s) into the blended low salinity injection water. Alternatively or additionally, other additive(s) may be combined with the fines stabilizing additive in fines stabilizing tank 20. Such additional additives are known to those of skill in the art and will not be detailed herein.

An ion concentration sensor S4 may be positioned on line 9 and operable to provide ion concentration data for the blended low salinity injection water therein. In some embodiments, ion sensor S4, alone or in combination with other sensor data, may be operable to determine a molar ratio of divalent cations to monovalent cations in the blended low salinity injection water (e.g., the combined RO permeate/fines stabilizing additive and optional SW and/or PW) in line 9. A flow rate sensor Q5 and/or Q6 may be positioned on line 9 and operable to provide flow rate data for the blended low salinity injection water therein.

As depicted in the embodiment of FIG. 2 and noted above, by-pass line 3B can be utilized to introduce high salinity desalination feed water into the blending system, whereby the low salinity injection water can further comprise by-passed feed water (e.g., sea water). In such embodiments, an ion concentration sensor S5 can be utilized to provide ion concentration data of the high salinity by-pass stream in high salinity by-pass line 3B. A flow rate sensor Q7 may be positioned on high salinity by-pass line 3B and operable to provide flow rate data for the high salinity feed water by-pass stream therein. By-pass valve V3 can be utilized to control the flow rate in the high salinity by-pass stream in high salinity by-pass line 3B.

As depicted in the embodiment of FIG. 3 and noted above, the fluids produced from a production well 24 are passed to the production facility 50 via production line 28. The produced fluids are separated in the production facility 50 into an oil stream 51, a gaseous stream 52 and a produced water (PW) stream. In some embodiments, all or a portion of the PW flows via a PW blending stream to the blending system via PW blending line 27 where it is injected into the combined RO permeate/fines stabilizing additive blending stream (and optionally by-pass water and additional additive(s)) flowing through line 9 to form a blended low salinity injection water stream. In such embodiments, an ion concentration sensor S6 can be utilized to provide ion concentration data on the PW in PW blending line 27 and/or an ion concentration sensor S7 can be utilized to provide ion concentration data on the low salinity injection water after introduction of the PW blending stream. A flow rate sensor Q8 can be utilized to measure the flow rate of the PW in PW blending line 27. A flow rate sensor Q9 can be utilized to measure the flow rate of the low salinity injection water after introduction of the PW blending stream. A PW valve V5 can be operable to control the flow rate of the PW in PW blending line 27. In such embodiments, the low salinity injection water in line 9 can further comprise produced water, introduced via PW blending line 27.

It is envisaged that the RO permeate, the fines stabilizing additive, optional PW, optional SW and optional further additive (e.g., a clay-stabilizing concentrate) blending streams may be combined in any order, including at a single blending point. The blended low salinity injection water stream can be injected into the injection well 21 via one or more injection pumps P3 and injection lines 11 of the injection system 40.

The integrated system of the present disclosure may be located on a platform or a Floating Production Storage and Offloading facility (FPSO) and may be used for injecting a blended low salinity injection water stream into at least one oil-bearing layer of an offshore reservoir. Alternatively, the desalination plant of the integrated system of the present disclosure may be located onshore and the RO permeate stream may be delivered to a blending system located on a platform or FPSO for blending with the fines stabilizing additive blending stream.

The control unit 30 of the integrated system may include a CPU (Central Processing Unit), a RAM (Random Access Memory), a ROM (Read Only Memory), a HDD (Hard Disk Drive), I/F (Interfaces), computer-executable code (e.g., software and/or firmware), and the like.

Boundary values for the composition of the blended low salinity injection water stream injected via injection line 11 for the main phase of the low salinity waterflood may be inputted into the control unit 30 of the integrated system I/II/III. These boundary values define an operating envelope for the composition of the blended low salinity injection water stream. The operating envelope may be defined by boundary values (upper and lower limits) for one or more of the TDS content (salinity), ionic strength, the concentrations of individual ions (such as sulfate anions, nitrate anions, calcium cations, magnesium cations or potassium cations), the concentrations of types of individual ions (such as monovalent cations, monovalent anions, multivalent anions, multivalent cations, or divalent cations), ratios of types of individual ions (such as a ratio of divalent to monovalent cations), or ratios of individual ions (such as Sodium Adsorption Ratio).

In some embodiments, the blended low salinity injection water falls within an operating envelope comprising a salinity of less than or equal to 5,000, 4,000, 3,000, 2,000, 1,000, 500, 400, or 300 ppm, or less, and/or a salinity in a range of from about 150 to about 5000 ppm, from about 150 to about 1000 ppm, or from about 150 to about 500 ppm. In some embodiments, the blended low salinity injection water falls within an operating envelope comprising a molar ratio of divalent cations to monovalent cations in a range of from about 0.1 to about 0.4, from about 0.1 to about 0.3, or from about 0.2 to about 0.2; and/or greater than or equal to about 0.1, 0.2, 0.3, or 0.4.

Sodium Adsorption Ratio (SAR) can be used to assess the state of flocculation or of dispersion of clays in the reservoir rock. Typically, sodium cations facilitate dispersion of clay particles while calcium and magnesium cations promote their flocculation. A formula for calculating the Sodium Adsorption Ratio (SAR) is:

SAR=[Na⁺]/{√(0.5*([Ca²⁺]+[Mg²⁺]))},

wherein sodium, calcium, and magnesium cation concentrations of the blended low salinity injection water are expressed in milliequivalents/liter. In some embodiments, the low salinity injection water has an SAR of less than or equal to about 5, 4, 3, 2, or 1.5, greater than or equal to about 0.1, 0.2, or 0.3, and/or in a range of from about 0.2 to about 5, from about 0.2 to about 4, from about 0.2 to about 3, or from about 0.2 to about 2.

Compositions within the operating envelope are those predicted to achieve enhanced oil recovery (EOR) from the reservoir while avoiding or minimizing the risk of formation damage. Where there is a souring risk or scaling risk for the reservoir, compositions within the operating envelope can be those that are also predicted to mitigate reservoir souring or inhibit scaling. The person skilled in the art will understand that not all reservoirs present a souring risk or a scaling risk. Thus, souring may occur when a reservoir contains an indigenous population of sulfate reducing bacteria (SRB) that obtain energy by oxidizing organic compounds while reducing sulfate to hydrogen sulfide. Scaling may occur when a connate water containing high levels of precipitate precursor cations such as barium and strontium cations mixes with an injection water containing relatively high amounts of sulfate anions resulting in the precipitation of insoluble sulfate salts (mineral scales). In some embodiments, utilization of fines stabilizing additive comprising, consisting of, or consisting essentially of calcium nitrate in production of a low salinity injection water of this disclosure can provide souring control.

Different boundary values for each parameter may be inputted into the control unit 30, thereby defining different operating envelopes for the composition of the blended low salinity injection water where the different operating envelopes balance different levels of enhanced oil recovery (EOR) with different levels of risk of formation damage, reservoir souring or scaling.

In order to maintain the composition of the blended low salinity water within a predefined or predetermined operating envelope for the composition of the blended low salinity injection water for the main phase of the low salinity flood, the amount of the RO permeate stream and/or the fines stabilizing additive blending stream may be adjusted in real time in response to changes (increases or decreases) in the composition (increases or decreases in the TDS content, concentration of one or more individual ions, concentration of one or more types of individual ions, a ratio of individual ions or a ratio of types of individual ions) of the RO permeate, optional high salinity by-pass water, optional PW blending water, and/or the blended low salinity injection water.

In some embodiments, in the blending system of the integrated system of the present disclosure, the amount of the RO permeate available for blending with the fines stabilizing additive blending stream (and/or the optional SW bypass stream and/or the optional PW blending stream) to form the blended low salinity injection water stream may be rapidly adjusted (in real time) by discharging varying amounts of the RO permeate stream from the blending system, for example, into a body of water (the ocean), via the RO permeate “dump line” 4 that is provided with a “dump valve” V1. In some embodiments, the dump valve V1 is an adjustable valve (e.g., a throttle valve) that may be set to various positions (between a fully closed and fully open position) to adjust the amounts of RO permeate discharged from the blending system.

If the discharge of excess RO permeate continues for a prolonged period of time, for example, hours or days, then the control unit 30 may make adjustments to the desalination plant 1 by taking one or more of the RO units of the RO array 10 off-line thereby reducing the production capacity of RO permeate. If the discharge of excess RO permeate continues for weeks or months, optionally, the RO elements of one or more of the RO units may be placed offline.

It is known that divalent cations may be beneficial for stabilizing clays. Optionally, the desalination plant of this disclosure may comprise the by-pass line 3B for the high salinity water used as feed to the RO arrays 10 of the plant as this high salinity feed water (for example, seawater (SW)) typically contains high levels of divalent cations. As described hereinabove, this by-pass line 3B can be used for delivering a high salinity water blending stream (for example, a SW blending stream) to the blending system. Accordingly, the blending system optionally has a high salinity feed by-pass line. The by-pass line 3B for the high salinity feed water may be provided with an adjustable valve (e.g., a throttle valve) V3 that may be set to various positions between a fully closed and fully open position thereby providing variable amounts of high salinity water (e.g. SW) for blending with the RO permeate stream in RO permeate line 5 and the fines stabilizing additive blending stream in fines stabilizing blending line 8 to form the blended low salinity injection water. However, if desired, any excess high salinity water may also be discharged from the blending system to the ocean via a high salinity water dump line provided with an adjustable valve (e.g. a throttle valve). The use of an adjustable valve V3 on the optional SW by-pass line 3B (or on a SW dump line provided with an adjustable valve) also allows for rapid adjustments (in real time) to the composition of the blended low salinity injection water stream.

The control unit 30 may therefore alter the amount of any high salinity water (e.g. SW) included in the blended low salinity injection water stream in response to changes in the amount or quality of the RO permeate blending stream, the optional SW by-pass stream, the optional PW blending stream, the fines stabilizing additive blending stream, or the blended low salinity water stream to maintain the composition of the blended low salinity water stream within the predetermined (preselected) operating envelope. The person skilled in the art will understand that SW contains high levels of sulfate anions. Accordingly, when blending the RO permeate stream in RO permeate line 5 and fines stabilizing additive blending stream in fines stabilizing additive blending line 8 with SW any souring or scaling risk for the reservoir R can be appropriately managed.

The souring risk or scaling risk for a reservoir R may be managed by inputting into control unit 30 an upper limit (boundary value) for the sulfate concentration of the blended low salinity injection water, and utilization of ion sensors that provide sulfate measurements of the various blending streams. Such upper limit for the sulfate concentration of the low salinity injection water can be, for example, 100 mg/L, 50 mg/L, or 40 mg/L.

The blending system of an integrated system (e.g., integrated system I/II/III) of this disclosure may comprise at least one tank (e.g., for storing a concentrate comprising an aqueous solution or dispersion of the fines stabilizing additive) and at least one feed line 8 for delivering the concentrate. The concentrate feed line 8 may be provided with an adjustable valve V4 (e.g. a throttle valve) that may be set to various positions between a fully closed and fully open position, thereby providing variable amounts of concentrate for blending with the RO permeate (and optional SW by-pass and/or PW blending streams in by-pass line 3B and PW blending line 27, respectively) to maintain the composition of the blended low salinity injection water within the operating envelope. Alternatively or additionally, the concentrate tank 20 may be provided with a metering pump P2 that provides an accurate amount of concentrate for blending, and a flow rate meter Q4 that may be used to adjust the flow rate of the concentrate. The control unit 30 may therefore monitor the flow rate of the concentrate stream in the concentrate feed line 8 in real time and may make rapid adjustments to the flow rate of the concentrate using the adjustable valve, thereby changing the concentration of the fines stabilizing additive in the blended injection water stream. Accordingly, the control unit may also change the operation of the blending system in response to changes in the amount or quality of the RO permeate blending stream, (and/or the optional SW bypass stream and optional PW blending stream), or the blended low salinity injection water stream to adjust the amount of fines stabilizing additive in the blended low salinity injection water stream, thereby maintaining the composition within the operating envelope.

Utilizing a blended low salinity injection water that comprises or comprises primarily, consists essentially of, or consists of RO permeate and fines stabilizing additive, as described herein, wherein the amount of RO permeate that is blended can be rapidly adjusted, in embodiments, via an RO permeate dump line 6 and associated RO permeate dump valve V2, and the amount of the fines stabilizing additive that is blended can be rapidly adjusted via an adjustable valve V4 (e.g., throttle valve) and/or metering pump P2 on the fines stabilizing additive concentrate feed line 8 that delivers fines stabilizing additive concentrate from the concentrate tank 20 can, in some embodiments, provide for rapid adjustment of the composition of the resulting blended low salinity injection water, as needed during low salinity water-flooding.

As noted hereinabove, the blending system of the integrated system of this disclosure may further comprise an additional tank, as described above, for the introduction of other components (e.g., one or more clay stabilizing additives), or, alternatively, such other additives may be introduced via the concentrate tank 20 configured to introduce the fines stabilizing additive. In such embodiments, the operating envelope may be further defined by boundary values for the additional components (e.g., an optional further clay stabilizing additive(s)).

The control unit may automatically adjust the operation of the blending system and, hence, the amounts of the RO permeate stream in RO permeate line 5, the fines stabilizing additive blending stream in fines stabilizing additive blending line 8 (and of any optional high salinity water blending stream, such as SW by-pass stream in high salinity by-pass line 3B, PW blending stream in PW blending line 27, and/or any optional additional additive stream) that are included in the blended low salinity injection water stream in response to variations on the quantity and/or quality of the RO permeate, the fines stabilizing additive blending stream, (and optionally the SW by-pass stream, the PW blending stream, and/or any other additive streams), and/or the blended low salinity injection water stream so as to keep the composition of the injection water within the inputted boundary values that define the operating envelope for the blended low salinity injection water. Thus, the flow rate and composition of the RO permeate stream may be monitored in real time. Similarly, the flow rate and composition of the blended low salinity injection water may be monitored in real time to determine whether changes made by the control unit to the operation of the blending system to maintain the composition of the blended low salinity injection water within the operating envelope are effective. If not, the control unit 30 may make further changes to the operation of the blending system. Accordingly, in some embodiments, the control unit 30 has a feedback loop for controlling blending of the blended low salinity water stream.

In some embodiments, controlling the amount of RO permeate that is available for blending in real time by changing the amount of RO permeate discharged from the blending system via an RO permeate dump line 6, for example, into a body of water (e.g. the ocean), provides a robust control of TDS content and/or of the concentrations of the one or more individual ions within the operating envelope for the blended low salinity injection water stream, which responds rapidly to changes in the quantity or quality of the blended low salinity injection water. Thus, there can be a faster response than if an attempt was made to change the flow rates of feed water to the RO arrays 10 of the desalination plant (owing to the dead volumes in the feed lines leading from the RO arrays 10 to the blending point(s) for the blended low salinity injection water stream).

Further, where a high salinity water (e.g., SW in by-pass line 3B) or PW is available as a blending stream, controlling the degree of opening of the adjustable (variable) valve V3 (e.g., throttle valve) on the high salinity water by-pass line 3B or PW blending line 27 can be utilized to maintain the composition of the blended low salinity injection water within the predetermined operating envelope.

It can therefore be seen that the control unit 30 may alter the operation of the blending system in real time by adjusting one of more of the opening degree of the valve V2 on the RO permeate dump line 6, the opening degree of a valve on the fines stabilizing additive blending line 8, the opening degree of the valve V3 on the optional high salinity water by-pass line 3B, or the opening degree of the valve V5 on the optional PW blending line 27.

As noted hereinabove, various sensors may be included in the integrated system of the present disclosure, in particular in the blending system. These sensors may be used to determine the TDS and/or ionic composition of the blended low salinity injection water stream. For example, the TDS of the blended low salinity injection water stream may be determined from its conductivity, while the concentrations of individual ions or types of individual ions may be determined using glass sensors having membranes that are permeable to specific individual ions or specific types of individual ions. Such sensors may be present on the RO permeate lines 5, the fines stabilizing additive blending line 8, the optional high salinity water by-pass line 3B, and/or the optional PW blending line 27 to obtain data relating to the TDS and ionic composition of the RO permeate stream, fines stabilizing additive blending stream, the optional high salinity by-pass water stream, and/or the PW blending stream, respectively. In some embodiments, the sensors are operable to determine a ratio of divalent cations to monovalent cations. As further noted hereinabove, flow rate sensors may also be provided for determining the flow rates of the various blending streams (RO permeate stream in RO permeate blending line 5, fines stabilizing additive blending stream in fines stabilizing additive blending line 8, the optional high salinity feed water stream in by-pass line 3B, the optional PW blending stream in PW bending line 27, and/or any optional additional additive streams) and/or for determining the flow rate of RO permeate in the optional RO permeate dump line 6.

Accordingly, the blending system may have:
(a) Concentration sensors (e.g., ion concentration sensors) for measuring the salinity or total concentration of dissolved solids (Ct), concentrations of individual ions (Ci) or types of individual ions, or ratios of ions (e.g., molar ratio of divalent to monovalent ions) in one or more of:the RO permeate, the fines stabilizing additive blending stream, and optional high salinity water (e.g. SW) by-pass stream, the optional PW blending stream, optional additional additive stream(s), and the blended low salinity injection water stream. In particular, the blending system may have ion concentration sensors for measuring at least one of TDS concentration, chloride anion concentration, bromide anion concentration, calcium cation concentration, magnesium cation concentration, potassium cation concentration, sodium cation concentration, nitrate anion concentration and sulfate anion concentration for one or more of the RO permeate stream, the fines stabilizing additive blending stream, the blended low salinity injection water stream and the optional SW and/or PW blending streams. If the composition of the fines stabilizing additive blending stream is not expected to change, the composition of the fines stabilizing additive blending stream may not be measured regularly, in some embodiments.
(b) Flow rate sensors for measuring the flow rates of one or more of: the RO permeate blending stream, the RO permeate dump stream, the fines stabilizing additive blending stream, the optional high salinity water (e.g., SW) by-pass stream, the optional PW blending stream, any other optional additive streams, and the blended low salinity injection water stream. The ion concentration sensors, the flow rate sensors, and any other sensors described herein may communicate with the control unit 30 through any suitable communication technology, such as a direct electrical connection or a wireless electrical connection (e.g., Wi-Fi, Bluetooth).

Optionally, owing to the risk of formation damage during a low salinity water flood, a maximum permitted increase in downhole pressure or wellhead pressure (or a maximum permitted reduction in flow rate for the injection water stream (e.g., in injection line 11) downstream of the injection pump(s) (e.g., injection pump P3)), beyond which there is an unacceptable reduction in injectivity, may be inputted into the control unit 30. An increase in downhole pressure or wellhead pressure and a decrease in flow rate downstream of the injection pump(s) P3 indicate loss of injectivity arising from formation damage.

Optionally, the downhole pressure in the injection well 21 adjacent the oil-bearing layer 22 of the reservoir R or the wellhead pressure (or the flow rate of the blended low salinity injection water downstream of the injection pump(s) for the injection system of the reservoir) may be monitored in real time. The flow rate of the blended low salinity injection water downstream of injection pump P3 can be measured, for example, via flow rate sensor Q6. The pressure in the injection well may be monitored with a downhole measurement device such as a pressure sensor 23 that is linked to the control unit 30, for example, via a fibre optic telemetry line.

If the control unit 30 determines there is a decline in injectivity, the control unit 30 may select a different operating envelope for the composition of the blended injection water stream that is predicted to have a lower risk of causing formation damage (while maintaining an acceptable level of EOR from the oil-bearing layer(s) 22 of the reservoir R) and may then adjust the blending ratios of the various blending streams such that the injection water composition falls within the different operating envelope. The control unit 30 continues to monitor the downhole pressure or the wellhead pressure (or the flow rate downstream of the injection pump(s) P3) in real time to determine if the pressure (or flow rate) begins to stabilize in response to injection of a blended low salinity injection water having a composition within the preferred operating window. If not, the control unit 30 may make further changes to the operation of the blending system to adjust the composition of the blended low salinity injection water stream to fall within yet another preferred operating envelope that is predicted to have yet a lower risk of causing formation damage. This process is iterative and may be repeated many times. Optionally, the control unit 30 may take a decision to reduce the flow rate (e.g., measured by flow rate sensor Q6) of the injection water or stop injecting the injection water into an injection well 21 if the pressure continues to rise. The control unit 30 may then take the decision to inject a clay-stabilizing composition into the oil-bearing layers of the reservoir for a period of several days before recommencing the low salinity waterflood.

Typically, correlations are inputted into the control unit 30 between the mixing ratios of the various blending streams and the composition of the blended low salinity injection water stream (for example, correlations between the mixing ratios of the various blending streams and one or more of the TDS, osmotic strength, concentrations of individual ions, concentrations of types of individual ions, ratios of individual ions and ratios of types of individual ions of the blended low salinity injection water stream). These correlations may be based on the assumption that the compositions for the RO permeate and fines stabilizing additive blending stream (and/or the optional high salinity water (e.g. SW) blending stream) remain substantially constant (within predetermined tolerances) during operation of the desalination plant. In contrast, as discussed above, the composition of an optional PW blending stream may vary over the life of the low salinity waterflood. The mixing ratios of the various blending streams are dependent upon the flow rates of the various blending streams that are supplied to a mixing (blend) point(s) of the blending system to form the blended low salinity injection water stream.

Correlations may also be inputted into the control unit 30 between the opening degree of the RO dump valve V2 on RO dump line 6, the opening degree of an adjustable valve V4 on the fines stabilizer additive line 8, the opening degree of the adjustable valve V3 on the optional high salinity water by-pass line 3B, and/or the opening degree of the adjustable valve V5 on the optional PW blending line 27 and the flow rates of the RO permeate, fines stabilizing additive, and optional high salinity water and PW blending streams. The control unit 30 may therefore control the blending ratios and hence the composition of the blended low salinity injection water stream by changing the opening degrees of one or more of the above-identified adjustable valves to achieve a composition for the blended low salinity injection water within the predefined (preselected or predetermined) operating envelope. As a result, the flow rates of the various blending streams to be supplied to the mixing point(s) may be adjusted in real time, thereby ensuring the composition of the blended low salinity water lies within the predefined operating envelope.

Generally, lower TDS ranges provide higher EOR while higher TDS ranges mitigate the risk of formation damage, especially in reservoirs comprising rocks with high levels of swellable clays. However, utilization of a low salinity injection water of this disclosure comprising fines stabilizing additive in conjunction with RO water can enable the use of a lower total salinity or TDS than conventional. In some embodiments of this disclosure, the boundary values for the TDS of the herein disclosed low salinity injection water during the main phase of the low salinity waterflood may be in the range of from 100 to 500 mg/L, from 100 to 5,000, or from 100 to 10,000 mg/L. Alternative boundary values for the TDS may be, for example, in the range of 500 to 10,000 mg/L, 300 to 10,000 mg/L, 100 to 9000 mg/L, 100 to 8000 mg/L, or 100 to 7000 mg/L (depending on the risk of formation damage). In some embodiments, the boundary values for the TDS of the herein disclosed low salinity injection water during the main phase of the low salinity water flood may be less than or equal to about 10,000, 9,000, 8,000, 7,000, 6,000, 5,000, 4,000, 3,000, 2,000, 1,000, or 500 ppm, greater than or equal to 100, 200, 300, 400, or 500 ppm, or a combination thereof. The control unit 30 may control the composition of the blended low salinity injection water to within a selected range for the boundary values for the TDS.

Typically, the control unit 30 controls the sulfate anion concentration of the blended low salinity injection water to a value of less than 100 mg/L; less than 50 mg/L, or less than 40 mg/L.

Typically, the control unit 30 controls the total multivalent cation concentration of the blended injection water to within the range of 1 to 250 mg/L; 3 to 150 mg/L, or 50 to 150 mg/L with the proviso that a ratio of the divalent to monovalent cations is as described hereinabove (e.g., greater than or equal to about 0.4, 0.3, 0.2, or 0.1), and/or with the optional proviso that the ratio of the multivalent cation content of the blended low salinity injection water to the multivalent cation content of the connate water is less than 1.

Typically, the control unit 30 controls a ratio of the calcium cation concentration of the blended low salinity injection water to monovalent cations in a range of greater than or equal to about 0.4, 0.3, 0.2, or 0.1, optionally with the proviso that the ratio of the calcium cation content of the blended low salinity injection water to the calcium cation content of the connate water is less than 1.

Typically, the control unit 30 controls a ratio of the magnesium cation concentration of the blended low salinity injection water to monovalent cations in a range of greater than or equal to about 0.4, 0.3, 0.2, or 0.1, optionally with the proviso that the ratio of the magnesium cation content of the blended low salinity injection water to the magnesium cation content of the connate water is less than 1.

In embodiments, the control unit 30 controls the potassium cation concentration of the blended low salinity injection water to within the range of 10 to 2000 mg/L and, in particular, 250 to 1000 mg/L, with the proviso that the TDS of the blended low salinity injection water remains within the boundary values for the predefined operating envelope.

The boundary values for the TDS and concentrations of individual ions vary depending on the low salinity EOR response for the reservoir and the composition of the rock of the oil-bearing layers of the reservoir, and in particular, on the levels of swellable and migratable clays and minerals that are known to be linked to formation damage.

The boundary values may have been determined by analyzing a sample of rock taken from the oil-bearing layer 22 of the reservoir R. The samples of the reservoir rock may be, for example, rock cuttings, or a side wall core. Alternatively, the reservoir rock surrounding an injection well 21 may be analyzed by geophysical logging using a downhole logging apparatus. Analysis of the rock may include, but is not limited to, identifying the presence (and quantity) of clays and identifying types of clays (and their quantities). Analytical methods for quantifying clays may include geophysical logging, X-ray diffraction (XRD), scanning electron microscopy (SEM), infrared scintillation point counting or sieve analysis. In some further embodiments of the disclosure, analysis of the rock formation may comprise determining an amount of clays in the range from about 2 weight % to about 20 weight %. Analysis of the rock may also include determining the mineral content of the clay fraction of the rock, in particular, clays of the smectite type (such as montmorillonite), pyrophyllite type, kaolinite type, illite type, chlorite type and glauconite type, which can be determined by X-ray diffraction (XRD) or scanning electron microscopy (SEM) analysis. The optimal salinity for the main phase of the waterflood may be determined from correlations of formation damage occurring with different salinity boundary values for the injection water for a range of rock samples with different clay contents and clay compositions and selecting boundary values for the salinity for a rock sample that most closely matches the composition of the rock (e.g., using historical data) for the reservoir that is to be subjected to the low salinity waterflood. Alternatively, experiments may be performed on samples of the rock taken from the region of the reservoir where the injection well 21 has been drilled using different boundary values for the salinity and composition of individual ions for the blended low salinity injection water to determine an optimal envelope for the salinity and composition (e.g., molar ratio of divalent to monovalent cations) for the injection water for the main phase of the waterflood.

Typically, the injection capacity for the blended low salinity injection water is limited owing to the limited capacity of the desalination plant or the need to dispose of increasing amounts of produced water over the life of a low salinity water flood. Accordingly, the low salinity waterflood may be designed to inject a low pore volume (PV) slug of the blended low salinity injection water into the oil-bearing layer of the reservoir from a first injection well in an amount of at least 0.3 pore volumes or at least 0.4 pore volumes as slugs having these minimum pore volumes tend to maintain their integrity within the formation. In order to limit the amount of water injected into the reservoir from an injection well, in some embodiments, the pore volume of the blended low salinity injection water is less than 1 PV, less than or equal to 0.9 PV, less than or equal to 0.7 PV, less than or equal to 0.6 PV, less than or equal to 0.5 PV, or less than or equal to 0.4 PV.

After injection of the low (e.g., fractional, less than 1) pore volume of the blended low salinity injection water into the first injection well, a drive water may be injected from the injection well into the oil-bearing layer 22 of the reservoir R to ensure that the slug of blended low salinity injection water (and hence the bank of released oil) is swept through the oil-bearing layer 22 of the reservoir R to the production well 24. In addition, the injection of the drive water may be required to maintain the pressure in the reservoir. Typically, the drive water has a greater PV than the slug of injection fluid (e.g., aqueous displacement fluid).

In some embodiments, the drive water is produced water or a mixture of seawater and produced water, depending on the amount of produced water separated at the production facility 50. The use of produced water as a drive water is advantageous owing to the restrictions on disposal of produced water into the sea. Accordingly, following injection of the slug of low salinity injection water, the first injection well may be used as a produced water disposal well. However, as discussed above, owing to increasing amounts of PW being separated from gas and oil at the production facility 50 as the low salinity waterflood progresses, it may be necessary to dispose of a portion of the PW in a further slug of blended low salinity injection water that is injected into one or more further low salinity injection wells. These injection wells may be wells that have previously been used for injection of SW or may be low salinity injection wells that are brought into commission either during or following injection of a slug of blended low salinity injection water into the first low salinity injection well.

As discussed above, boundary values for the composition of the blended low salinity injection water (for example, boundary values for the TDS content, concentrations of one or more individual ions, concentrations of types of individual ions, concentration ratios of individual ions, concentration ratios of types of individual ions or the concentrations of one or more clay stabilizing additives in the blended low salinity injection water) are inputted into the control unit 30 thereby defining an operating envelope (e.g.. a first operating envelope) that maximizes EOR from the oil bearing layer 22 of the reservoir R whilst mitigating the risk of formation damage, souring or scaling of the reservoir.

Typically, different compositions for the blended low salinity injection water (TDS, concentrations of one or more individual ions, concentrations of types of individual ions, concentration ratios of individual ions, concentration ratios of types of individual ions or concentrations of one or more clay-stabilizing additives) are correlated with different blend ratios for the RO permeate stream and the fines stabilizing additive blending stream (and optionally of the optional high salinity by-pass stream and/or PW blending stream), or different flow rates of the RO permeate stream and the fines stabilizing additive blending stream (and optionally the high salinity by-pass stream and/or the PW blending stream) to the blending point or different percent volumes of the RO permeate stream and the fines stabilizing additive blending stream (and optionally the high salinity by-pass stream and/or the PW blending stream) in the blended low salinity injection water stream. The different compositions can also be correlated with different compositions of a PW stream and with different compositions for the combined RO permeate/fines additive blending stream (including compositions that include SW and one or more additional additives). These correlations may be inputted into the control unit so that the control unit 30 may control the operation of the blending system to alter the blend ratio of the RO permeate stream with the fines stabilizing additive blending stream, or the flow rate of the combined RO permeate stream/fines stabilizing additive blending stream or percentage volumes of the RO permeate stream in the blended low salinity injection water stream) to provide a composition for the blended low salinity injection water falling within the operating envelope.

As discussed above, the quantity (flow rate) and/or quality (composition) of the RO permeate may vary over time. The control unit 30 may send instructions to alter the operation of the blending system, in real time in response to changes in the quantity and/or quantity of the RO permeate, to alter the flow rate and/or composition of the RO permeate stream that is blended with the fines stabilizing additive blending such that the composition of the blended low salinity injection water stream remains within the operating envelope (e.g., the first operating envelope). For example, the blending ratio of the RO permeate stream and the fines stabilizing additive blending stream (and hence the composition of the blended low salinity injection stream) and the flow rate (amount) of the RO permeate stream and/or the fines stabilizing additive blending stream may be adjusted by the control unit 30 sending instructions to vary the degree of opening of the throttle valve V2 on the RO permeate dump line 6 and/or the valve V4 on fines stabilizing additive line 8.

The control unit 52 may also alter the operation of the blending system, in real time, to adjust the flow rates (amounts) of optional SW, optional PW blending water, and/or other additives (e.g., clay-stabilizers) included in the blended low salinity injection water stream. Thus, for example, the control unit 30 may send instructions to vary the degree of opening of the throttle valves V3 and/or V5 on the optional SW by-pass line 3B and the optional PW blending line 27 respectively.

In some embodiments, the control unit 30 may monitor the flow rate and composition of the optional PW blending stream in real time using flow rate sensor Q8 and sensor S6, respectively, on the PW flow line 27 and also the flow rate and composition of the combined RO permeate stream/fines stabilizing additive blending stream 9 (with or without SW bypass) in real time using flow rate sensor Q5 or Q6 and sensor S4, respectively, to determine whether the changes made to the operation of the plant were effective in maintaining the composition of the blended low salinity injection water within the operating envelope. If not, the control unit 30 may make further adjustments to the operation of the blending system.

Thus, in some embodiments the integrated system of any of FIGS. 1-3 for producing the blended low salinity injection water stream can have a control unit 30 that includes a feedback loop that enables the integrated system to continuously adjust the composition of the blended low salinity injection water stream to remain within the operating envelope in response to changes, such as changes in the quantity or quality of the RO permeate stream and/or a PW blending stream.

It is also envisaged that alternative boundary values may be inputted into the control unit 30 where the alternative boundary values define alternative operating envelopes (second, third, etc. operation envelopes) for the composition of the blended low salinity injection water that may further mitigate the risk of formation damage, souring or scaling of the reservoir while maintaining acceptable EOR from the reservoir.

Accordingly, in addition to maintaining the composition of the blended injection water within an operating envelope (e.g. first operating envelope), the control unit 30 may monitor pressure sensor 23 for any increase in pressure adjacent the oil-bearing interval 22 of the injection well 21 or may monitor the flow sensor Q6 located downstream of the injection pump(s) P3 of the injection system 40 for any decrease in flow rate (both of which may be indicative of an unacceptable decrease in injectivity arising from formation damage). Values for a maximum permitted increase in pressure and/or a maximum permitted decrease in flow rate may be inputted into the control unit 30 (where these values are correlated with an acceptable decrease in injectivity). If the pressure in the injection well 21 adjacent the oil-bearing interval 22 increases to a value that approaches or reaches the maximum permitted increase in pressure or the flow rate downstream of the injection pump(s) P3 decreases to a value that approaches or reaches the maximum permitted decrease in flow rate, the control unit 30 may select an alternative operating envelope for the composition of the blended low salinity injection water (e.g. one of the second, third etc. operating envelopes) that is predicted to reduce the risk of formation damage. For example, the alternative operating envelope for the composition of the blended low salinity injection water may be defined by one or more of: higher boundary values for the TDS; higher boundary values for divalent cation content (in particular calcium cation content); or, higher boundary values for one or more clay stabilizing additives. The control unit 30 may then control the operation of the blending system to adjust the composition and flow rate of the combined RO permeate/fines stabilizing additive blending stream such that the blended injection water stream has a composition falling within the alternative operating envelope. For example, this may be achieved by the control unit 30 sending instructions to increase the amount of RO permeate dumped via the RO permeate dump line 6, to increase the divalent cation content of the blended low salinity injection water stream by increasing the amount of the fines stabilizing additive blending stream (when it comprises a higher divalent cations) and/or of the optional SW in the blended low salinity injection water, or, to increase the amount of an additional clay-stabilizing concentrate additive in the blended low salinity injection water stream (by changing the degree of opening of one or more of throttle valves V2, V4 or V3 respectively). The control unit 30 may monitor the impact of the change in operation of the blending system on the flow rate or composition of the blended low salinity injection water stream (using flow rate sensor Q6 and sensor S4, respectively), to determine if the adjustments to the operation of the plant have resulted in the flow rate and composition of the blended injection water stream falling within the alternative operating envelope and, if necessary, may make further adjustments to the operation of the blending system to achieve a composition within the alterative operating envelope. Thus, the integrated system of any of FIGS. 1-3 has a control unit 30 with a feedback loop that enables the blending system to produce a blended low salinity injection water stream 9 falling within an alternative operating envelope.

It is envisaged that where there are a plurality of injection wells 21 that there may be dedicated injection water lines 11 for each injection well 21 and that the integrated system of the present disclosure may be used to produce blended injection water streams having compositions specifically tailored for each injection well.

Where a low pore volume (e.g., less than 1 PV) slug of the blended low salinity injection water has been injected into at least one of the plurality of injection wells, for example, into injection well 21, it is envisaged that the dedicated injection line 11 for the injection well may be used to inject PW (e.g., from PW flow line 27) or a blend of SW and PW (from high salinity by-pass line 3B and PW flow line 27) as an aqueous drive fluid for driving the low pore volume slug of blended low salinity injection water and hence a bank of released oil toward the production well 21. Accordingly, the RO permeate and fines stabilizing additive blending streams are no longer required for injection well 21 and may be diverted for producing one or more blended low salinity injection water streams for one or more alternative injection wells.

### Features and Potential Advantages of the Herein-Disclosed Low Salinity Injection Water Generation System and Method

As the herein disclosed system and method for generating low salinity injection water enables utilization of a desalination plant comprising one type of membrane (e.g., RO, without NF) and does not require blending of two different desalination permeates (e.g., RO permeate and NF permeate), the herein disclosed system and method provide simplification of the production of a low salinity injection water. Utilization of a fines stabilizing additive in combination with an RO permeate to provide a low salinity injection water as per this disclosure can provide for more rapid adjustment and enhanced control of a composition (e.g., a molar ratio of divalent cations to monovalent cations) of the resulting low salinity injection water, in some embodiments. Utilization of the blended low salinity injection water comprising RO permeate and fines stabilizing additive as per this disclosure can enable operation of low salinity EOR water flooding at a lower overall salinity (e.g., less than or equal to about 500, 400, 300, 200, 150, or 100 ppm) than conventionally utilized (e.g., 1000 to 5000 or 10,000 ppm), which may provide for enhanced oil recovery without compromising injectivity and/or permeability of the reservoir.

While various embodiments have been shown and described, modifications thereof can be made by one skilled in the art without departing from the spirit and teachings of the disclosure. The embodiments described herein are exemplary only, and are not intended to be limiting. Many variations and modifications of the subject matter disclosed herein are possible and are within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R_{L} and an upper limit, R_{U} is disclosed, any number falling within the range is specifically disclosed. In particular, the following numbers within the range are specifically disclosed: R=R_{L}+k*(R_{U}−R_{L}), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the embodiments of the present disclosure. The discussion of a reference is not an admission that it is prior art to the present disclosure, especially any reference that may have a publication date after the priority date of this application. The disclosures of all patents, patent applications, and publications cited herein are hereby incorporated by reference, to the extent that they provide exemplary, procedural, or other details supplementary to those set forth herein.

### Additional Description

The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. Alternative embodiments that result from combining, integrating, and/or omitting features of the embodiment(s) are also within the scope of the disclosure. While compositions and methods are described in broader terms of “having”, “comprising,” “containing,” or “including” various components or steps, the compositions and methods can also “consist essentially of” or “consist of” the various components and steps. Use of the term “optionally” with respect to any element of a claim means that the element is required, or alternatively, the element is not required, both alternatives being within the scope of the claim.

Numbers and ranges disclosed above may vary by some amount. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces. If there is any conflict in the usages of a word or term in this specification and one or more patent or other documents, the definitions that are consistent with this specification should be adopted.

Embodiments disclosed herein include:
A: An integrated system comprising: a desalination plant comprising a reverse osmosis (RO) array configured to produce an RO permeate blending stream; a blending system comprising a flow line for a fines stabilizing additive blending stream and configured to blend the RO permeate blending stream with the fines stabilizing additive blending stream to produce a blended low salinity water stream having a salinity of less than or equal to 8,000, 7,000, 6,000, 5,000, 4,000, 3,000, 2,000, 1,000, 500, 400, or 300 ppm and a molar ratio of divalent cations to monovalent cations of greater than about 0.2, 0.3, or 0.4; a control unit configured to control operation of the blending system; and an injection system for one or more injection wells, wherein the one or more injection wells penetrate an oil-bearing layer of a reservoir.
B: A method comprising: producing a reverse osmosis (RO) permeate blending stream using an RO array of a desalination plant; providing a fines stabilizing additive blending stream; blending the RO permeate blending stream and the fines stabilizing additive blending stream in a blending system to produce a blended low salinity water stream having a salinity of less than or equal to 5,000, 4,000, 3,000, 2,000, 1,000, 500, 400, or 300 ppm and a molar ratio of divalent cations to monovalent cations of greater than or equal to about 0.2, 0.3, or 0.4.
C: An integrated system comprising: a control unit; a plurality of valves controlled by the control unit; a plurality of flow rate and composition monitors configured to provide measured flow rate data and composition data, respectively, to the control unit; a reverse osmosis (RO) array configured to produce an RO permeate blending stream; a fines stabilizing additive tank configured to provide a fines stabilizing additive blending stream; and a blending system comprising a line configured to blend the RO permeate blending stream and the fines stabilizing additive blending stream into a blended low salinity water stream having a salinity of less than or equal to 5,000, 4,000, 3,000, 2,000, 1,000, 500, 400, or 300 ppm and a molar ratio of divalent cations to monovalent cations of greater than or equal to about 0.2, 0.3, or 0.4, wherein the control unit is configured to: adjust, in response to the measured flow rate and composition data, at least one of the plurality of valves to maintain a composition of the blended low salinity water stream within a predetermined operating envelope.
D: A low salinity injection fluid for use in enhanced oil recovery (EOR), the low salinity injection fluid comprising: a reverse osmosis (RO) permeate stream, where the reverse osmosis permeate stream can correspond to from about 80 to about 99.995 volume percent (vol %) of the low salinity injection fluid, and a fines stabilizing additive, where the fines stabilizing additive corresponds to from about 0.005 to about 20 vol % of the low salinity injection fluid, wherein the fines stabilizing additive comprises a salt of a divalent cation.
Each of embodiments A, B, C, and D may have one or more of the following additional elements: Element 1: wherein the control unit is configured to: dynamically alter operation of the blending system to adjust amounts of at least one of the RO permeate blending stream or the fines stabilizing additive blending stream to maintain a composition of the blended low salinity water stream within a predetermined operating envelope that includes the salinity of less than or equal to 5,000, 4,000, 3,000, 2,000, 1,000, 500, 400, or 300 ppm and the molar ratio of divalent cations to monovalent cations of greater than about 0.2, 0.3, or 0.4. Element 2: wherein the control unit is configured to receive the operating envelope from a source external to the control unit. Element 3: wherein the operating envelope specifies upper and lower limits for at least one parameter selected from the group consisting of: total dissolved solids (TDS) content; ionic strength; concentrations of individual ions; concentration of types of individual ions; ratios of types of individual ions; and ratios of individual ions. Element 4: wherein the at least one parameter comprises the molar ratio of divalent cations to monovalent cations. Element 5: further comprising an RO permeate dump line, a sea water (SW) bypass line, a produced water (PW) blending line, or a combination thereof, and wherein the control unit is further configured to dynamically adjust an amount of the RO permeate discharged from the blending system via the RO permeate dump line, an amount of a high salinity water by-pass stream that by-passes the desalination plant via the SW bypass line and feeds SW to the blending system, an amount of a PW stream that feeds PW to the blending system via the PW blending line, or a combination thereof. Element 6: wherein: (i) the blended low salinity water stream comprises RO permeate stream that is about 80 to about 99.995 volume percent (vol %) of the blended low salinity water stream, and the fines stabilizing additive blending stream that is about 0.005 to about 20 vol % of the blended low salinity water stream; (ii) the fines stabilizing additive blending stream comprises calcium chloride (CaCl₂)), calcium nitrate (Ca(NO₃)₂), potassium chloride (KCl), potassium nitrate (KNO₃), ammonium chloride ((NH₄)Cl), magnesium chloride (MgCl₂), or a combination thereof; or (iii) both (i) and (ii). Element 7: wherein blending further comprises blending seawater (SW), produced water (PW), or both with the RO permeate blending stream and the fines stabilizing additive blending stream in the blending system to produce the blended low salinity water stream. Element 8: further comprising dynamically adjusting operation of the blending system to adjust amounts of the RO permeate blending stream, the fines stabilizing additive blending stream, or both to maintain a composition of the blended low salinity water stream within a predetermined operating envelope that includes the salinity of less than or equal to 5,000, 4,000, 3,000, 2,000, 1,000, 500, 400, or 300 ppm and the molar ratio of divalent cations to monovalent cations of greater than about or equal to about 0.2, 0.3, or 0.4. Element 9: wherein dynamically adjusting the operation of the blending system comprises adjusting at least one valve in the blending system. Element 10: wherein the at least one valve comprises a valve on a fines stabilizing additive blending line that feeds the fines stabilizing additive blending stream to the blending system, a valve on a high salinity water by-pass line that by-passes the desalination plant and feeds sea water (SW) to the blending system, a valve on a produced water (PW) blending line that feeds PW to the blending system, a valve on an RO permeate dump line configured to discharge RO permeate from the blending system, or a combination thereof. Element 11: wherein the blended low salinity water stream has a divalent cation content in a range of from about 0.01 to about 20 milliequivalents/liter. Element 12: wherein: (i) the RO permeate stream (or RO/NF blend) comprises from about 80 to about 99.995 volume percent (vol %) of the blended low salinity water stream, and the fines stabilizing additive blending stream comprises from about 0.005 to about 20 vol % of the blended low salinity water stream; ii) the fines stabilizing additive blending stream comprises primarily calcium chloride (CaCl₂)), calcium nitrate (Ca(NO₃)₂), potassium chloride (KCl), potassium nitrate (KNO₃), ammonium chloride ((NH₄)Cl), magnesium chloride (MgCl₂), or a combination thereof; or (iii) both (i) and (ii). Element 13: wherein the flow rate data and composition data pertain to the blended low salinity water stream. Element 14: further comprising an injection system configured to deliver the blended low salinity water stream to a formation via an injection well. Element 15: wherein the operating envelope specifies upper and lower limits for at least one parameter selected from the group consisting of: total dissolved solids (TDS) content; ionic strength; concentrations of individual ions; concentration of types of individual ions; ratios of types of individual ions; and ratios of individual ions. Element 16: further comprising a sea water (SW) bypass line that by-passes the RO array and feeds sea water (SW) to the blending system, a produced water (PW) blending line that feeds PW to the blending system, or both. Element 17: having a total dissolved solids (TDS) of less than or equal to about 500, 400, or 300 mg/L. Element 18: having a molar ratio of divalent cations to monovalent cations of greater than or equal to about 0.2, 0.3, or 0.4.

While embodiments of the invention have been shown and described, modifications thereof can be made by one skilled in the art without departing from the teachings of this disclosure. The embodiments described herein are exemplary only, and are not intended to be limiting. Many variations and modifications of the invention disclosed herein are possible and are within the scope of the invention.

Numerous other modifications, equivalents, and alternatives, will become apparent to those skilled in the art once the above disclosure is fully appreciated. It is intended that the following claims be interpreted to embrace all such modifications, equivalents, and alternatives where applicable. Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the detailed description of the present invention. The disclosures of all patents, patent applications, and publications cited herein are hereby incorporated by reference.

1. An integrated system comprising:
a desalination plant comprising a reverse osmosis (RO) array configured to produce an RO permeate blending stream;
a blending system comprising a flow line for a fines stabilizing additive blending stream and configured to blend the RO permeate blending stream with the fines stabilizing additive blending stream to produce a blended low salinity water stream having a salinity of less than or equal to 5,000, 4,000, 3,000, 2,000, 1,000, 500, 400, or 300 ppm and a molar ratio of divalent cations to monovalent cations of greater than about 0.2, 0.3, or 0.4;
a control unit configured to control operation of the blending system; and
an injection system for one or more injection wells, wherein the one or more injection wells penetrate an oil-bearing layer of a reservoir.

2. The integrated system of claim 1, wherein the control unit is configured to:
dynamically alter operation of the blending system to adjust amounts of at least one of the RO permeate blending stream or the fines stabilizing additive blending stream to maintain a composition of the blended low salinity water stream within a predetermined operating envelope that includes the salinity of less than or equal to 5,000, 4,000, 3,000, 2,000, 1,000, 500, 400, or 300 ppm and the molar ratio of divalent cations to monovalent cations of greater than about 0.2, 0.3, or 0.4.

3. The integrated system of claim 2, wherein the control unit is configured to receive the operating envelope from a source external to the control unit.

4. The integrated system claim 2, wherein the operating envelope specifies upper and lower limits for at least one parameter selected from the group consisting of: total dissolved solids (TDS) content; ionic strength; concentrations of individual ions; concentration of types of individual ions; ratios of types of individual ions; and ratios of individual ions.

5. The integrated system of claim 4, wherein the at least one parameter comprises the molar ratio of divalent cations to monovalent cations.

6. The integrated system of claim 1 further comprising an RO permeate dump line, a sea water (SW) bypass line, a produced water (PW) blending line, or a combination thereof, and wherein the control unit is further configured to dynamically adjust an amount of the RO permeate discharged from the blending system via the RO permeate dump line, an amount of a high salinity water by-pass stream that by-passes the desalination plant via the SW bypass line and feeds SW to the blending system, an amount of a PW stream that feeds PW to the blending system via the PW blending line, or a combination thereof.

7. The integrated system of claim 1, wherein:
(i) the RO permeate stream corresponds to from about 80 to about 99.995 volume percent (vol %) of the blended low salinity water stream, and the fines stabilizing additive blending stream corresponds to about 0.005 to about 20 vol % of the blended low salinity water stream;
(ii) the fines stabilizing additive blending stream comprises calcium chloride (CaCl₂)), calcium nitrate (Ca(NO₃)₂), potassium chloride (KCl), potassium nitrate (KNO₃), ammonium chloride ((NH₄)Cl), magnesium chloride (MgCl₂), or a combination thereof; or
(iii) both (i) and (ii).

8. A method comprising:
producing a reverse osmosis (RO) permeate blending stream using an RO array of a desalination plant;
providing a fines stabilizing additive blending stream;
blending the RO permeate blending stream and the fines stabilizing additive blending stream in a blending system to produce a blended low salinity water stream having a salinity of less than or equal to 5,000, 4,000, 3,000, 2,000, 1,000, 500, 400, or 300 ppm and a molar ratio of divalent cations to monovalent cations of greater than or equal to about 0.2, 0.3, or 0.4.

9. The method of claim 8, wherein blending further comprises blending seawater (SW), produced water (PW), or both with the RO permeate blending stream and the fines stabilizing additive blending stream in the blending system to produce the blended low salinity water stream.

10. The method of claim 8 further comprising dynamically adjusting operation of the blending system to adjust amounts of the RO permeate blending stream, the fines stabilizing additive blending stream, or both to maintain a composition of the blended low salinity water stream within a predetermined operating envelope that includes the salinity of less than or equal to 5,000, 4,000, 3,000, 2,000, 1,000, 500, 400, or 300 ppm and the molar ratio of divalent cations to monovalent cations of greater than about or equal to about 0.2, 0.3, or 0.4.

11. The method of claim 10, wherein dynamically adjusting the operation of the blending system comprises adjusting at least one valve in the blending system.

12. The method of claim 11, wherein the at least one valve comprises a valve on a fines stabilizing additive blending line that feeds the fines stabilizing additive blending stream to the blending system, a valve on a high salinity water by-pass line that by-passes the desalination plant and feeds sea water (SW) to the blending system, a valve on a produced water (PW) blending line that feeds PW to the blending system, a valve on an RO permeate dump line configured to discharge RO permeate from the blending system, or a combination thereof.

13. The method of claim 8, wherein the blended low salinity water stream has a divalent cation content in a range of from about 0.01 to about 20 milliequivalents/liter.

14. The method of claim 8, wherein:
(i) the RO permeate stream corresponds to from about 80 to about 99.995 volume percent (vol %) of the blended low salinity water stream, and the fines stabilizing additive blending stream corresponds to from about 0.005 to about 20 vol % of the blended low salinity water stream;
(ii) the fines stabilizing additive blending stream comprises primarily calcium chloride (CaCl₂)), calcium nitrate (Ca(NO₃)₂), potassium chloride (KCl), potassium nitrate (KNO₃), ammonium chloride ((NH₄)Cl, magnesium chloride (MgCl₂), or a combination thereof; or
(iii) both (i) and (ii).

15. An integrated system comprising:
a control unit;
a plurality of valves controlled by the control unit;
a plurality of flow rate and composition monitors configured to provide measured flow rate data and composition data, respectively, to the control unit;
a reverse osmosis (RO) array configured to produce an RO permeate blending stream;
a fines stabilizing additive tank configured to provide a fines stabilizing additive blending stream; and
a blending system comprising a line configured to blend the RO permeate blending stream and the fines stabilizing additive blending stream into a blended low salinity water stream having a salinity of less than or equal to 5,000, 4,000, 3,000, 2,000, 1,000, 500, 400, or 300 ppm and a molar ratio of divalent cations to monovalent cations of greater than or equal to about 0.2, 0.3, or 0.4,
wherein the control unit is configured to:
adjust, in response to the measured flow rate and composition data, at least one of the plurality of valves to maintain a composition of the blended low salinity water stream within a predetermined operating envelope.

16. The integrated system of claim 15, wherein the flow rate data and composition data pertain to the blended low salinity water stream.

17. The integrated system of claim 15 further comprising an injection system configured to deliver the blended low salinity water stream to a formation via an injection well.

18. The integrated system claim 15, wherein the operating envelope specifies upper and lower limits for at least one parameter selected from the group consisting of: total dissolved solids (TDS) content; ionic strength; concentrations of individual ions; concentration of types of individual ions; ratios of types of individual ions; and ratios of individual ions.

19. The integrated system of claim 15 further comprising a sea water (SW) bypass line that by-passes the RO array and feeds sea water (SW) to the blending system, a produced water (PW) blending line that feeds PW to the blending system, or both.

20. A low salinity injection fluid for use in enhanced oil recovery (EOR), the low salinity injection fluid comprising:
a reverse osmosis (RO) permeate stream, wherein the reverse osmosis permeate stream corresponds to about 80 to about 99.995 volume percent (vol %) of the low salinity injection fluid;
a fines stabilizing additive, wherein the fines stabilizing additive corresponds to about 0.005 to about 20 vol % of the low salinity injection fluid, wherein the fines stabilizing additive comprises a salt of a divalent cation.

21. The low salinity injection fluid of claim 20, having a total dissolved solids (TDS) of less than or equal to about 500, 400, or 300 mg/L.

22. The low salinity injection fluid of claim 21 having a molar ratio of divalent cations to monovalent cations of greater than or equal to about 0.2, 0.3, or 0.4.
